(19) United States
(12) Patent Application Publication
(10) Pub. No.: US 2014/0302205 A1
(43) Pub. Date: Oct. 9, 2014

(54) METHOD AND DEVICE FOR PRODUCING COMMERCIAL MILK AND MILK HAVING REDUCED BIOLOGICAL ACTIVITY OF EXOSOMAL RIBONUCLEIC ACIDS

(71) Applicant: BODO C. MELNIK, GUETERSLOH (DE)

(72) Inventor: BODO C. MELNIK, GUETERSLOH (DE)

(21) Appl. No.: 13/923,963

(22) Filed: Jun. 21, 2013

Related U.S. Application Data
(63) Continuation of application No. PCT/DE2013/100142, filed on Apr. 18, 2013.

(30) Foreign Application Priority Data
Apr. 5, 2013 (DE) 102013103447.0

(51) Int. Cl. A23C 9/00; A23C 7/04

(52) U.S. Cl. CPC A23C 9/00; A23C 7/04; A23C 7/043
USPC 426/238; 426/580; 99/451

(57) ABSTRACT

Microribonucleic acids (abbreviated: miRs) which are present in milk, in particular cow's milk, are a serious health risk which was previously unrecognized by science as contributing to the development of the diseases of civilization, such as overweight, type 2 diabetes and cancer. Those diseases may be counteracted by inactivating undesirable biological activities of the miRs of milk by removing and/or destroying milk exosomes which are 50-100 nm in size that transport the miR. This is accomplished firstly by treating the skimmed milk fraction with 20 kHz ultrasound and/or removing the milk exosomes by immunoadsorption thereof and/or addition of RNAses before further conventional milk processing. This milk treatment serves the purpose of reducing activities that are harmful to health of the miR-mediated genetic signal systems of milk to long-term consumers and thereby improving product safety of milk and further processing products thereof.

### CROSS-REFERENCE TO RELATED APPLICATION

This application is a continuation, under 35 U.S.C. §120, of copending International Application No. PCT/DE2013/100142, filed Apr. 18, 2013, which designated the United States; this application also claims the priority, under 35 U.S.C. §119, of German Patent Application DE 10 2013 103 447.0, filed Apr. 5, 2013; the prior applications are herewith incorporated by reference in their entirety.

### BACKGROUND OF THE INVENTION

### Field of the Invention

The invention relates to a method and a device for producing commercial milk as well as to milk having reduced biological activity of exosomal ribonucleic acids.

Milk and milk products belong to the basic elements of western nutrition. The consumption of milk and milk products, such as yoghurt and cheese, has increased significantly in recent decades in industrialized countries by introducing extensive cooling technology in the middle of the 1950s, optimizing hygiene conditions, increasing the shelf-life of milk and milk products, and also increasing product variety.

The inventor of the instant application does not share the currently prevailing opinion that the health advantages of milk and milk product consumption outweigh the health disadvantages of milk consumption which are described hereinafter, since excessive milk and milk product consumption substantially raises the risk of suffering from diseases of civilization. Milk consumption during pregnancy increases fetal growth in size and the birth weight of neonates. An increased birth weight in girls is associated with an increased risk of breast cancer. A formula diet produced on the basis of cow's milk protein is causally associated with promotion of postnatal adipogenic misprogramming of babies and overweight in infants. Milk consumption in children increases their growth in height, increases their body mass index (BMI), and leads to premature occurrence of menarche, which has been recognized as a risk factor for premature occurrence of type 2 diabetes. Milk consumption favors the occurrence of acne, increases the risk of obesity, type 2 diabetes, prostate cancer and breast cancer, and therefore must be considered as an important promoter of diseases of western civilization. Milk-induced diseases of civilization are associated with increased cell growth, increased cell proliferation and anabolic reactions in metabolism. At a molecular biological level, an excessively increased activity of the central regulator of metabolism, the enzyme mTORC1 (mechanistic target of rapamycin complex 1; synonym: mammalian target of rapamycin complex 1), in this case plays a central role in the pathogenesis of mTORC1-associated diseases of civilization.

The present invention considers milk not to be an ordinary food, but a micro-ribonucleic acid (miR)-controlled messenger system for mTORC1 activation of the miR-regulated body cells, which acts as the physiological way of stimulating postnatal growth of mammals. The milk-induced mTORC1 activation proceeds, in the view of the inventor, in particular by transfer of regulatory micro-ribonucleic acids (miRs) of milk, which are transported in the form of very small nanoparticles called exosomes, to the recipient. Milk is the secretion product richest in miR at the beginning of the life of mammals. Human milk, compared with all other body fluids of humans, has the highest content of miRs. More than 245 miR species have been detected in cow's milk.

An miR has the capability of binding in a complementary manner to one of mRNAs that are to be regulated by complementary binding to respectively specific 3′ UTR regions and thereby inhibiting or completely switching off these mRNAs. miRs are therefore able to switch off the translation and formation of specific proteins.

In accordance with the insight of the inventor, milk induces growth by providing specific miRs which have the task of switching off regulatory proteins that inhibit the cell cycle, which are termed tumor-suppressor proteins, such as PTEN, PDCD4 and Sprouty.

In the opinion of the inventor, the miRs of milk which are continuously taken in by the consumer in biologically active form through milk consumption are of central importance for the harmful long-term biological effect of chronic milk consumption by humans. Of critical importance for the transfer are the approximately 50-100 nm microvesicles (exosomes) which are the optimum and prevailing transport form of the miRs of cow's milk.

These exosomes protect the miRs of milk from the acidic pH conditions of the gastrointestinal passage, against thermal denaturation (such as, for example, during the pasteurization of milk) and also against enzymatic inactivation by RNAses and permit the endocytosis thereof with cellular entry of the regulatorily active miRs into the target cells of the recipient. In the present intact exosomal transport form, the regulatory miRs of the milk can be taken in by the body cells of the milk recipient (of the baby or of the milk consumer). Milk, in the opinion of the inventor, functions similarly to a virus infection, as a genetic transfection system which applies mTORC1-activating miRs to the milk recipient.

One of the 7 miRs always present in cow's milk, which is present as a constant quality marker of milk during various lactation phases, is miR 21. It is a cause of great concern that miR 21 is considered as an oncogenic miR (oncomir 21), since it induces tumor growth, cell adherence, cell migration, invasion, motility and angiogenesis and therefore promotes metastasization. A constant miR-induced activation of the mTORC1 signal cascade, from the point of view of the inventor, is directly associated with known mTORC1-induced carcinogenesis and progression of cancer.

Cow's milk contains considerable amounts of the miR family let 7a, let 7b, let 7c and let 7f. These miRs play a critical role in the regulation of glucose metabolism. Data from animal experiments make it clear that overexpression of let 7 leads to insulin resistance and thereby favors the development of diabetes. The insulin resistance of stem cells of the fatty tissue of patients with obesity was able to be eliminated by inactivation of let 7. In the view of the inventor, the exogenous supply of let 7 proceeding from constant consumption of milk explains the insulin resistance induced by milk consumption and also the adipogenic activity of milk.

### SUMMARY OF THE INVENTION

It is accordingly an object of the invention to provide a method and a device for producing commercial milk and milk having reduced biological activity of exosomal ribonucleic acids, which overcome the hereinafore-mentioned disadvantages of the heretofore-known methods, devices and milks of this general type and which attenuate or eliminate health-hazardous biological miR activity of commercial milk which has been recognized for the first time by the inventor as a harmful factor for public health. Cow's milk may be mentioned, in particular, herein as commercial milk, but the invention likewise relates to all other animal milks such as, for example, buffalo's milk, goat's milk, ewe's milk or mare's milk.

With the foregoing and other objects in view there is provided, in accordance with the invention, a method for producing commercial milk having reduced biological activity of exosomal ribonucleic acids. The method comprises subjecting milk to an ultrasound treatment in a main method step, and destroying lipid membrane envelopes of exosomes transporting microribonucleic acids (miRs) in the milk by ultrasound during the main method step.

The critical factor for the stability and biological activity of the harmful miRs of milk is the transfer thereof in the form of exosomes, which are formed by the cow's mammary gland epithelium. Those membranous vesicles, usually 50 100 nm in size, contain a lipid membrane envelope which can be destroyed by ultrasound in accordance with the method of the invention, thereby preventing penetration of the milk miRs into body cells of milk consumers in an advantageously simple manner.

Ultrasound-induced destruction of the transport form of the miRs of milk in advance of further processing thereof therefore permits the removal of the disease-inducing biological activity of exosomal miRs of milk to humans and is therefore an advantageous measure for increasing the product safety of milk and milk products and decreasing the adverse gene-regulatory effects thereof.

In accordance with this invention, ultrasound is a suitable physical method for destruction of cow's milk exosomes. Damaging the structural integrity of milk exosomes and the cargo molecules thereof (primarily the miRs) is the primary objective of this invention. In order to achieve this purpose, the milk is sonicated with low-frequency ultrasound in the range of from 15 to 25 kHz, preferably 20 kHz. The destruction of liposomes and phospholipid vesicles on the size order of 100 nm was able to be demonstrated in various model systems by ultrasound treatment in the kHz range.

The starting material for the ultrasound treatment is preferably the skimmed milk fraction obtained after centrifugation (separation) of raw milk, with this fraction having been freed from the majority of the milk fat.

The lipid membranes of the exosomes of milk are made permeable by the ultrasound-induced transient cavitation. As a result of this sonoporation, the exosomes lose their contents, especially the undesirable regulatory miRs and mRNAs. After the ultrasound treatment, they are exposed unprotected to the RNAses occurring naturally in the milk, which cause further inactivation thereof. In a further modification of this method, in addition exogenous RNAses are supplied after the ultrasound treatment of the skimmed milk in order to optimize degradation of the miRs and mRNAs of the milk.

The skimmed milk is passed into sound-permeable containers. The temperature of the skimmed milk for sonication is 4° C. to a maximum of 25° C., preferably 7° C. The delivery acoustic power of the sonication heads is in the range of from 0.1 to 10 W/cm², preferably 5 W/cm². The pressure amplitudes are between 50 and 150 kPa, preferably 60 kPa. The ultrasound can be emitted either continuously or pulsed, e.g. 30 seconds' sonication, 3 minutes' pause, with acoustic sources that are planar or focused. The sonication time is in an interval of from 10 to 30 minutes, preferably 15 minutes. The milk either flows through an unjacketed, cooled, optionally meandering tube system past a number of series-connected sonication heads or is introduced into a flat cooled tub for the required period of time, on or in the bottom, cover and/or side walls of which the sonication heads are applied in the required density. Preferably, modified industrial ultrasound processors are used. Flow rates of the sonicated skimmed milk of approximately 5-10 m³ per hour or more are sought.

The exosomes contain characteristic marker proteins, tetraspanins CD37, CD53, CD63, CD81 and CD82. In milk exosomes, in particular the tetraspanins CD63 and CD81 have been detected. Glass beads or other support materials coated with anti-CD63 and/or anti-CD81 antibodies can be used for removal/reduction of the milk exosomes by immunoadhesion of milk exosomes. The antibody-coated glass beads or other inert materials are moved through the milk with careful stirring, and after an exposure time of 15-60 minutes, preferably 30 minutes, are separated off from the skimmed milk and reeluted for reuse.

A further immunoadsorption method proceeds by streaming the skimmed milk along antibody-coated surfaces which are formed of glass or suitable inert plastics. In this case the skimmed milk is brought into contact with anti-CD63 and/or anti-CD81-coated plates and incubated for a suitable time between 10 and 30 minutes, preferably 15 minutes, for adhesion of the exosomes. The plates with bound exosomes are separated from the skimmed milk. The exosomes are eluted from the plates by high-molar NaCl solution and these plates are used again for further use.

In order to increase the efficiency of the biological inactivation of milk exosome-transported miRs, both of the above-mentioned methods are combined sequentially. Preferably in this case, the immunoadhesion of the exosomes should precede the sonoporation of remaining exosomes.

Overall, using the method according to the invention and the correspondingly constructed device, a milk product may be provided which has a reduced biological activity of exosomal ribonucleic acids, wherein the treated skimmed milk can be mixed again with some of the previously optionally centrifuged-off milk fat fraction and homogenized in order then to be available as a milk substantially freed from a genetic signal action of bovine/animal miR/mRNA and harmless to consumers for direct consumption or for further processing to give known milk products. For this purpose, it should have passed through at least one of the above-mentioned method steps for reducing the biological activity of exosomal ribonucleic acids.

The structure of the exosomes is investigated after the described method by electron microscope analysis of the skimmed milk fraction compared with untreated skimmed milk. The decrease in content of CD63 and/or CD81 after immunoadsorption is tested, for example through a standardized Western Blot method or a CD63 or CD81-ELISA.

Other features which are considered as characteristic for the invention are set forth in the appended claims.

Although the invention is illustrated and described herein as embodied in a method and a device for producing commercial milk and milk having reduced biological activity of exosomal ribonucleic acids, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a flow diagram illustrating a first variant of a possible sequence of a milk refining method according to the invention;

FIG. 2 is a flow diagram illustrating a second variant of a possible sequence of a milk refining method according to the invention;

FIG. 3 is a longitudinal-sectional view of a cooled tube system according to the invention; and

FIG. 4 is a vertical-sectional view of a cooled tub according to the invention.

### DETAILED DESCRIPTION OF THE INVENTION

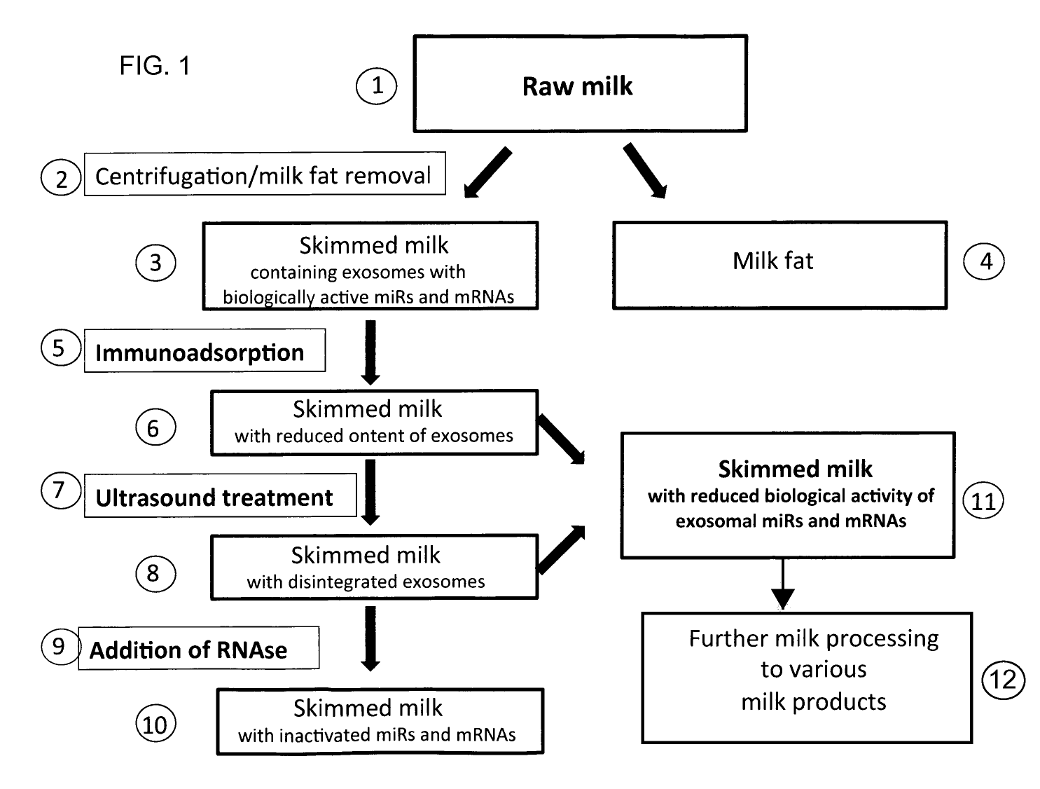

Referring now to the figures of the drawing in detail and first, particularly, to FIG. 1 thereof, there is seen a starting product 1, in this case untreated raw milk, of any animal species, which is separated in a first method step 2 by centrifugation to give skimmed milk 3 and milk fat 4, with biologically active exosomes being present in the skimmed milk 3. Then, in a further method step 5, immunoadsorption is carried out, which leads to skimmed milk 6 having a reduced exosome content. Then, the skimmed milk 6 is subjected in a main method step 7 to an ultrasound treatment 7, with skimmed milk 8 having destroyed exosome membranes being generated. Finally, in a last method step, an RNAse addition is performed which, as described above, leads to a skimmed milk 10 having deactivated RNA.

Each single one of the method steps 5, 7, 9 of immunoadsorption, ultrasound treatment and RNAse addition already leads to a skimmed milk 11 having a reduced biological activity of exosomal RNA, although the combination of all of the method steps achieves the greatest success, whereupon the milk 11 thus treated then passes into further processing 12 to give diverse milk products.

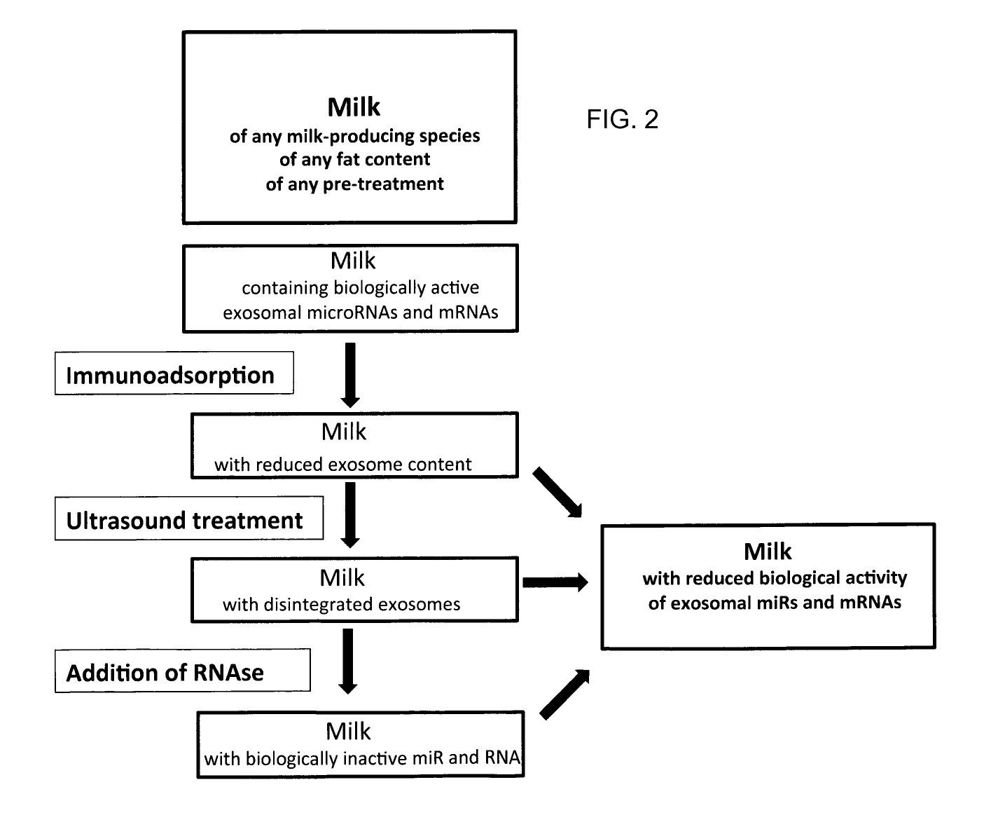

In the flow diagram of FIG. 2, the starting product is already pretreated, for instance pasteurized or even further processed milk, of any animal species. The milk contains biologically active exosomal microRNAs and mRNAs. The remainder of the method is the same as that shown in FIG. 1, starting with the immunoadsorption step.

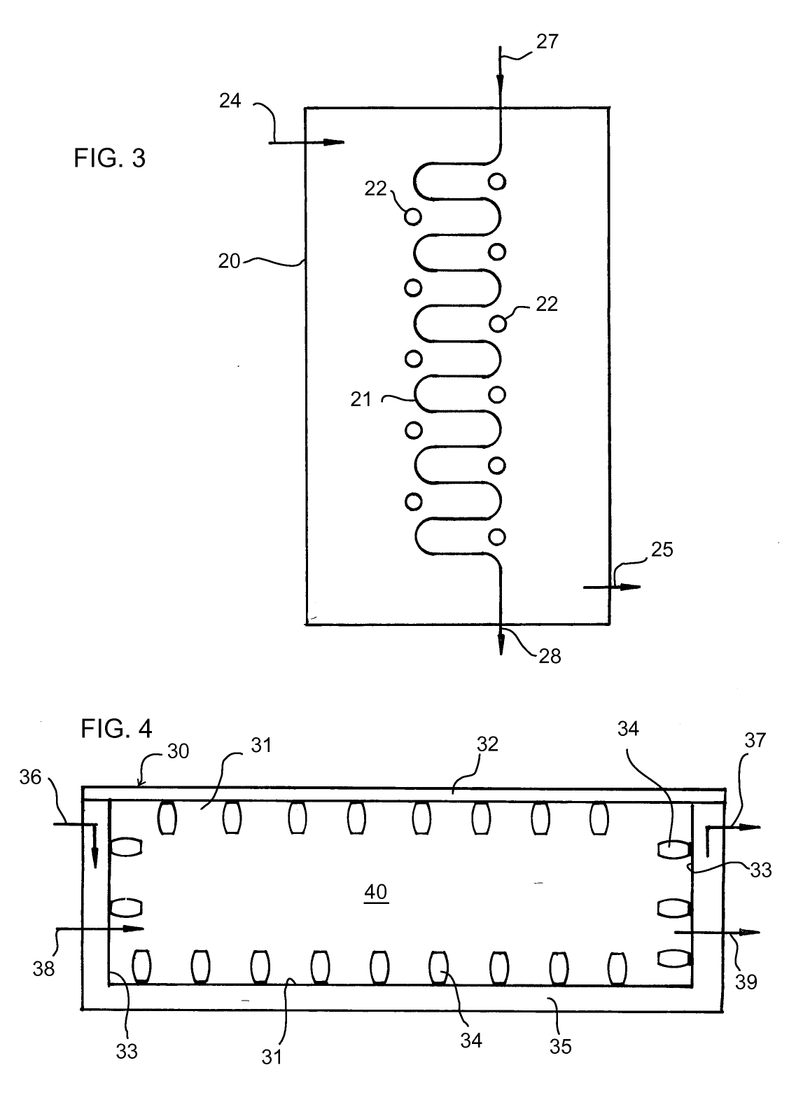

FIG. 3 is a longitudinal sectional view of a device 20 for producing commercial milk having reduced biological activity of exosomal ribonucleic acids by ultrasound treatment for disintegration of milk exosomes. The device 20 includes a cooled tube system 21 having a meandering or sinusoidal shape. A series of sonicating heads 22 is disposed along the cooled tube system 21. The sonicating heads 22 may be disposed one after the other and/or next to one another. A cooling liquid is supplied from an inlet 24 and travels through the device 20 to an outlet 25. Raw unprocessed milk containing biologically active exosomes enters the cooled tube system 21 through an inlet 27 and ultrasound-treated milk containing disrupted biologically inactive exosomes exits through an outlet 28.

FIG. 4 is a vertical-sectional view of a device 30 for producing commercial milk having reduced biological activity of exosomal ribonucleic acids by ultrasound treatment for disintegration of milk exosomes. The device 30 includes a flat cooled tub 35 having a bottom 31, a cover 32 and side walls 33. Sonication heads 34 are disposed at or in at least one of the bottom, cover or side walls. A cooling liquid is supplied from an inlet 36 and travels through an outer channel of the tub 35 to an outlet 37. Raw unprocessed milk containing biologically active exosomes enters the tub 35 through an inlet 38 and ultrasound-treated milk with disrupted biologically inactive exosomes exits through an outlet 39. Reference numeral 40 indicates milk in the tub which flows continuously over a horizontal meandering path along the sonication heads.

1. A method for producing commercial milk having reduced biological activity of exosomal ribonucleic acids, the method comprising the following steps:
subjecting milk to an ultrasound treatment in a main method step; and
destroying lipid membrane envelopes of exosomes transporting microribonucleic acids (miRs) in the milk by ultrasound during the main method step.

2. The method according to claim 1, which further comprises carrying out the ultrasound treatment of the milk using low-frequency ultrasound in a range between 15 kHz and 25 kHz in a temperature range of from 4° C. to 25° C.

3. The method according to claim 1, which further comprises carrying out sonication in the ultrasound treatment of the milk continuously or in pulses with intermediate pauses by using planar or focused acoustic sources.

4. The method according to claim 3, which further comprises carrying out the sonication at an interval of 10 to 30 minutes, at an acoustic power of 0.1 to 10 W/cm² and at pressure amplitudes between 50 and 150 kPa.

5. The method according to claim 1, which further comprises centrifuging the milk in a method step preceding the ultrasound treatment, and subjecting only a skimmed milk fraction obtained from the centrifuging step to the ultrasound treatment.

6. The method according to claim 1, which further comprises feeding exogenous RNAses to the ultrasound-treated milk in a method step following the main method step, the exogenous RNAses, in addition to RNAses naturally occurring in the milk, leading to an increased degradation of miRs and mRNAs of the milk released from the exosomes.

7. The method according to claim 1, which further comprises carrying out a further method step of an immunoadsorption method before or after the main method step, and moving antibody-coated support materials through the milk and/or conducting the milk along antibody-coated surfaces, in the immunoadsorption step.

8. The method according to claim 7, which further comprises carrying out the movement of the antibody-coated support materials through the milk over a period of 15 to 60 minutes, or carrying out the conduction along the antibody-coated surfaces for a period between 10 and 30 minutes.

9. Milk having reduced biological activity of exosomal ribonucleic acids, the milk comprising:
characteristics of reduced biological activity of exosomal ribonucleic acids imparted by subjecting the milk to immunoadsorption, ultrasound treatment or ultrasound treatment with subsequent RNAse addition.

10. A device for producing commercial milk having reduced biological activity of exosomal ribonucleic acids, the device comprising:
a cooled tube system having a series of sonicating heads disposed therein;
said sonicating heads being disposed at least one of one after the other or next to one another.

11. A device for producing commercial milk having reduced biological activity of exosomal ribonucleic acids, the device comprising:
a flat cooled tub having a bottom, a cover and side walls; and
sonication heads disposed at or in at least one of said bottom, said cover or said side walls.
